(19) United States
(12) Patent Application Publication
(10) Pub. No.: US 2015/0199754 A1
(43) Pub. Date: Jul. 16, 2015

(54) Intelligent Property Rental System

(71) Applicants: Alexander Greystoke, Lakeway, TX (US); Shy Blick, Austin, TX (US)

(72) Inventors: Alexander Greystoke, Lakeway, TX (US); Shy Blick, Austin, TX (US)

(21) Appl. No.: 14/603,227

(22) Filed: Jan. 22, 2015

Related U.S. Application Data
(63) Continuation-in-part of application No. 14/327,543, filed on Jul. 9, 2014.
Application No. 14/327,543 is a continuation-in-part of application No. 14/169,058, filed on Jan. 30, 2014.
Application No. 14/169,058 is a continuation-in-part of application No. 14/169,060, filed on Jan. 30, 2014.
(60) Provisional application No. 61/759,314, filed on Jan. 31, 2013.
(60) Provisional application No. 61/759,317, filed on Jan. 31, 2013.
(60) Provisional application No. 61/844,355, filed on Jul. 9, 2013.
(60) Provisional application No. 61/844,353, filed on Jul. 9, 2013.
(60) Provisional application No. 61/844,350, filed on Jul. 9, 2013.

(51) Int. Cl. G06Q 30/06; G06Q 50/16

(52) U.S. Cl. CPC G06Q 30/0645; G06Q 50/16

(57) ABSTRACT

In some embodiments, a system may include an interface configured to communicate with a device through a network. The system may further include an artificial intelligence engine configured to identify information corresponding to at least one of a potential renter and a first rental property and assess and value the information based on a context from which the information is identified. The artificial intelligence engine may also determine a recommendation corresponding to the renter or the rental property and may provide an interface to the device including the recommendation and a justification for the recommendation. In some embodiments, the system may automatically negotiate on behalf of one of the potential renter and the property owner and may selectively initiate communications between the potential renter and the property owner.

### CROSS-REFERENCE TO RELATED APPLICATION(S)

The present application is a continuation-in-part of and claims priority to U.S. patent application Ser. No. 14/327,543, filed on Jul. 9, 2014, and entitled “Computer-Aided Decision Systems,” which is a continuation-in-part of and claims priority to U.S. patent application Ser. No. 14/169,058, filed on Jan. 30, 2014, entitled “VIRTUAL PURCHASING ASSISTANT”, which claimed priority to U.S. Provisional Patent Application No. 61/759,314, filed on Jan. 31, 2013, and entitled “VIRTUAL PURCHASING ASSISTANT”; and is also a continuation-in-part of and claims priority to U.S. patent application Ser. No. 14/169,060 filed on Jan. 30, 2014, entitled “DUAL PUSH SALES OF TIME SENSITIVE INVENTORY”, which claimed priority to U.S. Provisional Patent Application No. 61/759,317, filed on Jan. 31, 2013, and entitled “DUAL PUSH SALES OF TIME SENSITIVE INVENTORY”; and is also a non-provisional of and claims priority to U.S. Provisional Patent Application No. 61/844,355, filed on Jul. 9, 2013, entitled “INVENTORY SEARCHING WITH AN INTELLIGENT RECOMMENDATION ENGINE”; is also a non-provisional of and claims priority to U.S. Provisional Patent Application No. 61/844,353, filed on Jul. 9, 2013, entitled “SINGLE PAGE TRAVEL SEARCH AND RESULTS MODIFICATION”; and is also a non-provisional of and claims priority to U.S. Provisional Patent Application No. 61/844,350, filed on Jul. 9, 2013, entitled “SEARCHING FOR INVENTORY USING AN ARTIFICIAL INTELLIGENCE PRIORITIZATION ENGINE”; the contents of all of which are hereby incorporated by reference in their entireties.

### FIELD

The present disclosure is generally related to property rental systems, and more particularly to property rental systems that apply artificial intelligence to align renters and property owners to facilitate renting of rental properties.

### BACKGROUND

Renting property can be challenging. Each renter may have different preferences with respect to choosing a rental property. A renter may want to choose the best property, but may have limited information from which to choose. Such information may be gathered from a listing, reviews (if available), and interactions with the homeowner. However, the renter may not be able to determine what information he or she may be missing, such as whether the property is as described, whether the property is well maintained and clean, whether the property is in a bad neighborhood or in a noisy location, or other information.

Additionally, the property rental sector includes unique characteristics, where the potential renter's behavior differs from the behavior of travelers in other contexts. In particular, property renters have less of a chance to be destination specific (as compared to a traveler booking an airline ticket), and thus the search and the decision-making process may be more property and property characteristic specific. In an example, a potential renter may be more flexible in terms of location if the property is the “right” property and is available at the “right” time. In this context, the term “right” embodies the renter's perspective, which may be influenced by various factors, including the amount of time that the renter has already spent searching when he/she finds the particular property.

Additionally, a property owner's objectives may be partially at odds with those of the potential renters. A property owner may want his or her properties to be as close to full occupancy as possible and at the highest rate possible. Further, the property owner wants quality renters who will take care of the property and not damage or otherwise devalue the property. However, property owners may have difficulty determining whether the potential renter is a good choice for his or her property and in particular may have difficulty managing risk arising from different types of renters.

### SUMMARY

In some embodiments, a system may include an interface configured to communicate with a device through a network. The system may further include an artificial intelligence engine configured to identify information corresponding to at least one of a potential renter and a first rental property and assess and value the information based on a context from which the information is identified. The artificial intelligence engine may also determine a recommendation corresponding to the at least one and may provide an interface to the device including the recommendation and a justification for the recommendation.

In other embodiments, a method may include automatically identifying information corresponding to at least one of a potential renter and a first rental property via an artificial intelligence engine. The method may further include automatically assessing and valuing, via the artificial intelligence engine, the information based on a context from which the information is identified and determining, via the artificial intelligence engine, a recommendation corresponding to the at least one. The method may further include providing an interface to a device via a network, the interface including the recommendation and a justification for the recommendation

In still other embodiments, a system may include an intelligent property rental system. The intelligent property rental system may include a renter artificial intelligence (AI) engine and a property owner/manager AI engine. The renter artificial intelligence (AI) engine may be adapted to provide a list of rental properties to a potential renter in response to a rental search. The list of rental properties may be customized to the potential renter based on one or more personas associated with the potential renter. The property owner/manager AI engine may be adapted to selectively interact with a property administrator and to identify risks associated with the one or more personas.

### BRIEF DESCRIPTION OF THE DRAWINGS

FIG. 1 is a block diagram of an intelligent property rental system for a renter, in accordance with certain embodiments of the present disclosure.

FIG. 2 is a block diagram of an intelligent property rental system for a property owner, in accordance with certain embodiments of the present disclosure.

FIG. 3 is a block diagram of a system including an intelligent property rental system, in accordance with certain embodiments of the present disclosure.

FIG. 4 is a block diagram of a system including an intelligent property rental system, in accordance with certain embodiments of the present disclosure.

FIG. 5 is a block diagram of a system including an intelligent property rental system, in accordance with certain embodiments of the present disclosure.

FIG. 6 is a flow diagram of a method of providing a recommendation to a potential renter, in accordance with certain embodiments of the present disclosure.

FIG. 7 is a flow diagram of a method of pushing an offer to a potential renter, in accordance with certain embodiments of the present disclosure.

FIG. 8 is a flow diagram of a method of automatically verifying availability of one or more rental properties, in accordance with certain embodiments of the present disclosure.

FIG. 9 is a flow diagram of a method of providing a recommendation to a potential renter based on review data and area information, in accordance with certain embodiments of the present disclosure.

FIG. 10 is a flow diagram of a method of providing a recommendation to a property owner or manager, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

In the following detailed description of embodiments, reference is made to the accompanying drawings which form a part hereof, and which are shown by way of illustrations. It is to be understood that features of various described embodiments may be combined, other embodiments may be utilized, and structural changes may be made without departing from the scope of the present disclosure. It is also to be understood that features of the various embodiments and examples herein can be combined, exchanged, or removed without departing from the scope of the present disclosure.

In accordance with various embodiments, the methods and functions described herein may be implemented as one or more software programs running on a computer processor or controller (or software implemented into a hardware equivalent, e.g., burned into a chip). In accordance with various embodiments, the methods and functions described herein may be implemented as one or more software programs running on a computing device, such as a tablet computer, smartphone, personal computer, server, or any other computing device. Dedicated hardware implementations including, but not limited to, application specific integrated circuits, programmable logic arrays, and other hardware devices can likewise be constructed to implement the methods and functions described herein. Further, the methods described herein may be implemented as a device, such as a computer readable storage medium or memory device, including instructions that when executed cause a processor to perform the methods.

In general, traveling from point A to point B introduces thousands of variables including various routes, various modes of transportation, timing variables, duration variable, costs, etc. The various choices can be difficult to evaluate in order to determine a “best” purchase option. However, finding a rental property may be more challenging than finding other travel products, in part, because the options are less limited and the decision points may be more fluid. For example, in some cases, the “destination” may be flexible in that the potential renter may be willing or able to select a property rental from a wide range of areas within a selected city or region (as compared to airports in that city or region, which may include one or two commercial airports and several private air ports) or may be willing or able to select from multiple cities or even countries. The range of options available to a potential renter may be much greater; however, identifying available properties that fit the traveler's criteria can be difficult for the potential renter. Not only may the destination be flexible, but rental properties often lack “branding”, and thus the traveler may have even harder time evaluating expectations from the final product. Property owners may be small business owners who may lack the infrastructure to create clear and targeted product descriptions, to provide customer support and to provide customer assurance for simple transaction services (e.g., credit card clearing). In many cases in today's markets, property owners may not even able to clearly advertise property availability. Embodiments of systems, methods, and apparatuses are described below that may facilitate communication between renters and property owners/managers. Further, the systems, methods, and apparatuses described below may include an artificial intelligence mechanism that may allow the renter to evaluate the property and may allow the property owner/manager to evaluate the potential renter.

Embodiments of intelligent property rental systems and methods are described below that may allow a potential renter to search for properties that meet his or her needs at the moment of search (in terms of date, accommodations, price, and so on). The systems and methods may include retrieving information about available properties that meet his or her needs (such as review data, area information (e.g., crime, proximity to activities and restaurants, etc.), retrieving information specific to the address from other sites), analyzing and evaluating the reliability of such information, and using that information to automatically make recommendations to the user. Further, the system may be configured to automatically verify availability with the property manager(s) prior to showing any choice to the user (or showing unverified choices as “unverified”) and to selectively provide advice to the potential renter regarding price negotiation strategies, and the like.

Embodiments of intelligent property rental systems and methods are also described below that may allow a property manager or property owner to identify potential risks associated with a potential renter. The system may determine information about the potential renter, may identify potential risks associated with the potential renter based on the selected information after assessing the value of that information, and may make recommendations to the property manager or property owner based on the information and its analysis of it. In some instances, the system may assist a property manager or property owner in risk mitigation or eradication or to select between potential renters based on the information or its analysis of it.

Further, embodiments of the intelligent property rental systems and methods may include a push-pull feature. In some embodiments, the system may identify a rental request evidenced through a search that may be nearly satisfied by parameters of a particular property. The system may push the rental request to a property manager or property owner associated with the particular property to allow the property manager or owner to communicate with the potential renter to offer his property, negotiate (or to optionally adjust his/her rental offerings, such as price, or upgrades) to entice the potential renter. In another embodiment, the system may receive a rental request and may push the rental request to multiple property managers or property owners or to one or more meeting the specifications to allow them to compete to entice the potential renter. The AI may determine the order in which the competing offers are communicated based on potential fit.

In some embodiments, a potential renter may post a request for a rental property having particular characteristics. In an example, the rental request may be for a two-bedroom rental property near the beach. The system may allow property owners/managers to view such requests (as well as other listings) and to respond to selected posts.

In still another embodiment, the system may push rental properties to the potential renter that are close to the parameters specified by the potential renter and may indicate that those “pushed” rental properties may have negotiable parameters, such as price. In some embodiments, the system may automatically take a lead in facilitating negotiations, such as by notifying the property manager or owner that the potential renter may be interested, but that the potential renter has requested a price point that is below that of the property manager or owner, allowing the property manager or owner to adjust the price to entice the potential renter. In some embodiments, negotiations can include an infinite number of back and forth exchanges. In some embodiments, the AI engine may be configured to make recommendations (to either party) or to advise of the likelihood of success at each stage of the negotiations. In some embodiments, the AI engine may also be configured to propose alternatives, additional elements, better steps (or language), and the like that may assist the user in achieving a successful outcome.

Embodiments of systems, methods, devices and logical elements are described herein that utilize digital personas in conjunction with artificial intelligence (AI) engines to provide a solution to a problem, which may be in reaction to a user input, such as a query or other input or which may be proactively identified by the persona. As used herein, a digital persona is a digital representation of an entity (a human, corporation, group, etc.), real or virtual, that has a set of preferences or rules in relation to a certain problem. A potential solution is a solution to a problem that may or may not relate to the priorities of a corresponding digital persona, as identified by user inputs or as determined from preferences or other information about the digital persona. In certain embodiments, a potential solution may represent a potential option that may be selected to satisfy one or more of the digital persona's needs or solve their problem. A chosen or selected solution is at least one of the potential solutions that, by way of weighing, was chosen to be appropriate (or most appropriate) to solve the problem or that was determined, based on scoring, to be the most satisfactory to the digital persona. An engine is a software mechanism that can process several tasks: such as determining digital persona preferences; obtaining a list of potential solutions; combining competing personas into a unified persona; selecting between competing personas to identify a subset of possible solutions; and determining optimal solutions with respect to specific situations.

A digital persona refers to a snapshot of information created by an artificial intelligence of any sort, e.g., machine learning, neural networks, evolutionary/genetic algorithms or other sorts, or a combination of some or all of these, to represent the preference and decision-making process of a represented entity, such as a user. The digital persona can be used to mimic, replace, supplement or otherwise enhance human or other entity behavior.

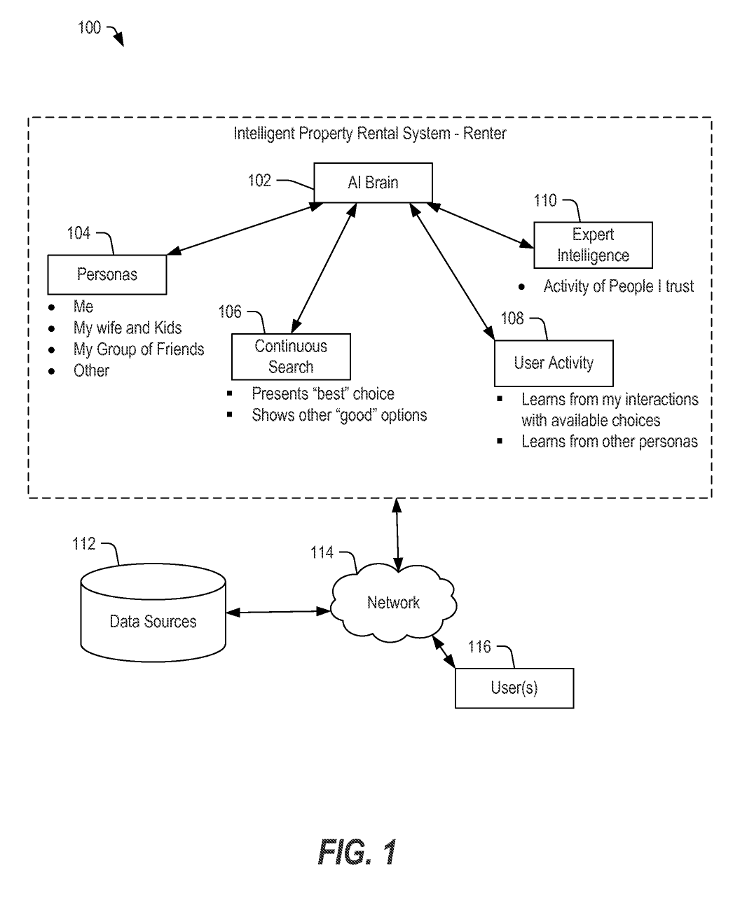

FIG. 1 is a block diagram of an intelligent property rental system 100, in accordance with certain embodiments of the present disclosure. The intelligent property rental system 100 may include an artificial intelligence (AI) brain 102, which may be a software application executing on one or more processors. The AI brain 102 may be configured to implement a property rental system, such as by retrieving data related to rental properties, determining further information about such properties, recommending properties as compared to other properties based on information about the properties or information about the potential renter (such as based on a persona associated with the potential renter), and optionally facilitating communications between the potential renter and the property owner and advising on them.

The intelligent rental property system 100 may include one or more personas (or digital personas) 104. A persona 104 may represent real-world entities within a digital universe of possibilities. In the illustrated example, a digital persona may represent an individual (e.g., me), a family (e.g., me, my wife, and my kids), a group (e.g., friends, colleagues, etc.), or other entities (e.g., a company, a team, an expert, and so on). Digital personas 104 evolve over time, in response to implicit and explicit feedback, in response to changes in the digital universe, in response to their own experience and the experiences of other personas. The AI brain 102 may update one or more of the personas 104 based on implicit or explicit feedback, based on decisions involving other personas, based on changing situations (such as changing inventory, evolving situations, and so on), based on context, or any combination thereof.

The intelligent property rental system 100 may also include continuous search 106, which may be used by the AI brain 102 to continuously search to find a “best” option, “better” options, and so on. The continuous search 106 may also cause the AI to determine other “good” options. The determination of “good”, “better”, and “best” may be based on various parameters associated with the persona 104 and, in some cases, based on empirical information. The “good”, “better”, and “best” options may be determined by the AI brain 102 on behalf of the potential renter, the property owner/manager, or both, either proactively or in response to a user request.

The intelligent property rental system 100 may further include a user activity module 108 that, when executed, may cause the AI brain 102 to learn from user interactions (implicit or explicit) with available choices and to learn from other personas. In some embodiments, the AI brain 102 may monitor user interactions with a set of search results and may learn from such user interactions. In some embodiments, the AI brain 102 may also learn from successes and failures (e.g., successful closing of a rental deal or failure to close the rental deal).

The intelligent property rental system 100 may also include expert intelligence 110, which may be used by the AI brain 102 to determine expert personas, from which the AI brain 102 may learn. In some embodiments, the AI brain 102 may determine “expert” personas from review data, from deals, and so on. An “expert” persona may be associated with a user who finds good price deals in locations that are well reviewed and at locations (properties, addresses, areas, etc.) that receive good reviews or who finds a diamond in the rough, an unexpected discovery.

The intelligent property rental system 100 may communicate with one or more data sources 112 through a network 114. The data sources 112 may include one or more databases including rental property information, as well as websites and other data sources including news, reviews, activity data, and other information. Further, the intelligent property rental system 100 may communicate with one or more users 116 through the network. Users 116 may include property managers/owners, property renters, potential renters, or any combination thereof. As used herein, the users 116 may be defined by their particular role when he or she interacts with the system 100, though a particular user may qualify for different roles depending on the particular context. For example, a property manager may use the system to manage property rentals in one context, and may use the system to look for a potential rental property in another context.

In some embodiments, the system 100 may be configured to receive a rental input from a user 116 via the network 114. The AI brain 102 may determine one or more personas for the user based on the rental input. The AI brain 102 may also search data sources 112 to identify rental properties corresponding to the rental input, and to determine review information and area information for each of the rental properties. In some embodiments, the area information may include crime statistics, traffic information, activity information, news information, and other information related to each rental property. In some embodiments, the review information may include review data from previous renters of the property, news about the property from local news sources, pictures or other information about the property determined from social media sites, information about the property manager or property owner, or any combination thereof. The system 100 may assess and value the area information and the review information and may selectively supplement the rental properties with the review information and the area information.

In some embodiments, the AI brain 102 may utilize the one or more personas to process a list of rental properties, the review information and the area information as assessed and valued to produce a customized list that is customized to the selected persona with comments and justification. Such customization may include the sort order, the types of rentals presented, and so on. Further, such customization may include excluding certain properties based on information about the property, the area, the owner/manager, other information, or any combination thereof and either showing/explain the exclusions or not.

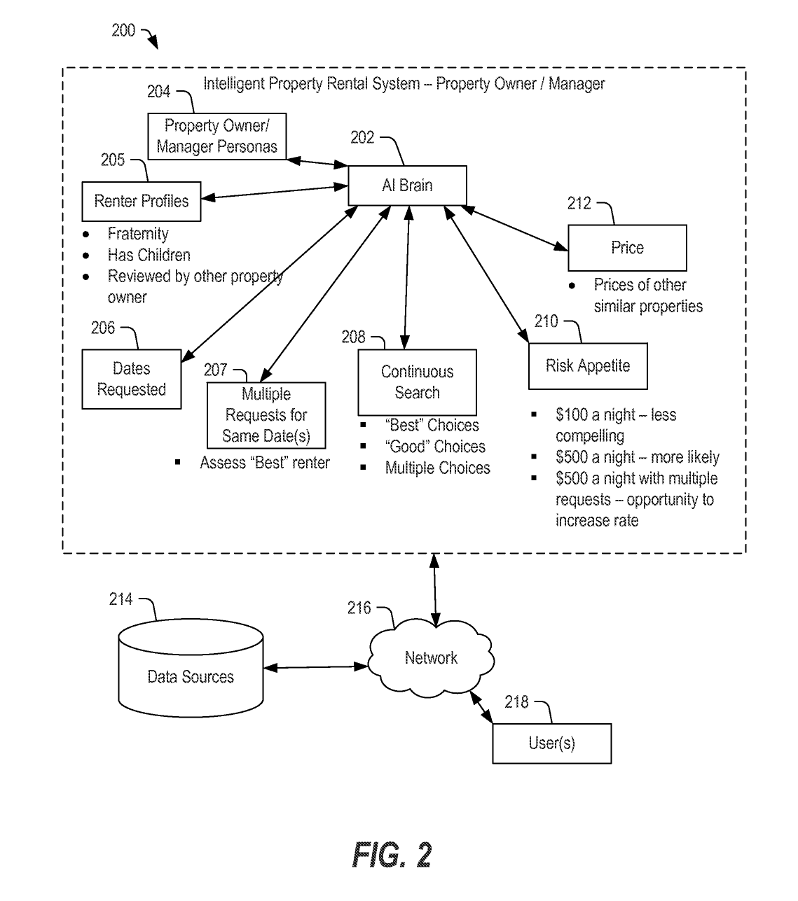

It should be appreciated that the intelligent property rental system 100 in FIG. 1 describes the system 100 from the perspective of a potential renter. However, the system may include a property owner/manager facing side, which may perform complementary functions and operations on behalf of the property owner/manager. One possible example of a property owner/manager facing system is described below with respect to FIG. 2.

FIG. 2 is a block diagram of an intelligent property rental system 200 for a property owner, in accordance with certain embodiments of the present disclosure. The system 200 may include all of the elements of the system 100 in FIG. 1. The intelligent property rental system 200 may include an AI brain 202, which may be a software application executing on one or more processors. The AI brain 202 may be an example of the AI brain 102 in FIG. 1 and may be configured to perform some or all of the methods and operations described with respect to the AI brain 102 in FIG. 1. In addition, the AI brain 202 may be configured to implement a property rental system, such as by receiving data related to rental requests, determining further information about a requester as well as information about the rental request, and providing options to allow a property manager/owner to assess the total economic value of each request, the true value of each request, to negotiate a rate with the potential renter, to accept or decline a rental request, and to mitigate risk with respect to a particular rental request.

The intelligent rental property system 200 may include one or more personas (or digital personas) 204. The personas 204 may represent real-world entities within a digital universe of possibilities, such as the property owner, a property manager, a property management organization, or any combination thereof. In the illustrated example, a digital persona 204 may represent an individual (e.g., a property owner), an organization (e.g., a corporation, a property management company, a consortium, etc.), and so on. Digital personas 204 may evolve over time, in response to implicit and explicit feedback, in response to changes in the digital universe, in response to their own experience and the experiences of other personas. In an example, digital personas 204 may evolve based on acceptance/rejection of a rental request, based on responses to push/pull options and to negotiations, and so on. The AI brain 202 may update one or more of the personas 204 based on implicit or explicit feedback, based on decisions involving other personas, based on changing situations (such as changing inventory, evolving situations, and so on), based on context, or any combination thereof.

The intelligent property rental system 200 may also take into account renter profiles 205, which may be determined based on feedback from other property owners/managers who have rented to this particular renter. The renter profiles 205 may be determined from such reviews as well as from information determined from other sources, such as data sources 214, which may cause the renter profiles 205 to change dynamically as new information is determined. Such renter profile information may include whether the renter is a fraternity/sorority member, whether the renter has children, whether the renter has been previously “reviewed” by other property owners/managers, and so on.

The intelligent property rental system 200 may further evaluate the dates requested 206 based on available inventory for the entirety of the date range. However, in some instances, the AI brain 202 may be able to determine a “near miss”, such as when the requested date range misses by one day on either end, and so on. In such an instance, the AI brain 202 may be able to determine when a particular property may be pushed to a potential renter to see if the potential renter may consider a slightly adjusted date range for a property that might otherwise meet his/her rental criteria (e.g., two bedrooms, a pool, etc.).

In some embodiments, the intelligent property rental system 200 may include a multiple requests module 207 for handling multiple requests for the same property for the same dates or for overlapping dates. In some embodiments, the multiple requests module 207 may be used by the AI brain 202 to make recommendations to a property owner/manager 204 based on renter profile information determined from the renter profiles module 205. The AI brain 202 may use the multiple requests module 207 to assess the “best” renter and other “good” renters from a set of renters. In some embodiments, the intelligent property rental system 200 may provide a mechanism by which a person with no review history or a poor review history may make a mitigation offer, such as an offer above the asking price or some other enhancement to entice the property owner to rent the property to him or her.

The intelligent property rental system 200 may further include a continuous search module 208, which may be used by the AI brain 202 to continuously search to find a “best” choices, “better” choices, multiple choices, and so on. The determination of “better” and “best” may be based on various parameters associated with the persona 204, renter profiles 205, and, in some cases, based on empirical information.

The intelligent property rental system 200 may further include a risk appetite (assessment) module 210 that, when executed, may cause the AI brain 202 to assess risk based on renter profile information, price, dates requested, historical and current information about demand, time of year, and other factors. Further, the AI brain 202 may assess a risk aversion of the property owner/manager to rate potential renters relative to one another and to determine risk remediation options, if any. The risk appetite module 210 may cause the AI brain 202 to make determinations based on potential renting options, including price, duration, and information about the renter (including purpose for the rental (e.g., bachelor party, spring break college trip, family vacation, etc.). In some examples, a five hundred ($500) dollar per night rental offer may be more compelling to the property owner/renter than a five hundred and fifty ($550) dollar per night rental offer, when the higher rental offer comes from a potential renter the presents a high potential risk. At a five hundred ($500) dollar per night rental rate, if multiple offers are received, the AI brain 202 may utilize the risk appetite module 210 and the multiple requests module 207 to evaluate the multiple offers and the risk and to recommend to the property owner/manager that an opportunity exists to increase the rate.

The intelligent property rental system 200 may also include a price module 212, which may be used by the AI brain 202 to evaluate user interactions with the intelligent property rental system 200, including searches that exclude a particular property based on price point, the rental rates of other similarly situated properties, and so on. The AI brain 202 may utilize the price module 212 to provide intelligent feedback to property owners/managers regarding market rates, and so on. In some embodiments, the price module 212 may be configured to dynamically adjust a price point of a particular property within a pre-determined range, at particular times of year, based on available inventory in the area, or any combination thereof. In some embodiments, the AI brain 202 may cooperate with the price module 212 to control an offering price of a particular rental property during a particular time of year to provide a first price to a first potential renter and a second price to a second potential renter. The first price may be higher than the second price. The price difference may be based on duration, renter profile information, changes in the rental inventory during a time period between when the first potential renter searched and the second potential renter searched, other factors, or any combination thereof.

The intelligent property rental system 200 may communicate with one or more data sources 214 through a network 216. The data sources 214 may include one or more databases including rental property information, as well as websites and other data sources including news, reviews, activity data, and other information. Further, the intelligent property rental system 200 may communicate with one or more users 218 through the network. Users 218 may include property managers/owners, property renters, potential renters, or any combination thereof. As used herein, the users 218 may be defined by their particular role when he or she interacts with the system 200, though a particular user may qualify for different roles depending on the particular context. For example, a property manager may use the system to manage property rentals in one context, and may use the system to look for a potential rental property in another context.

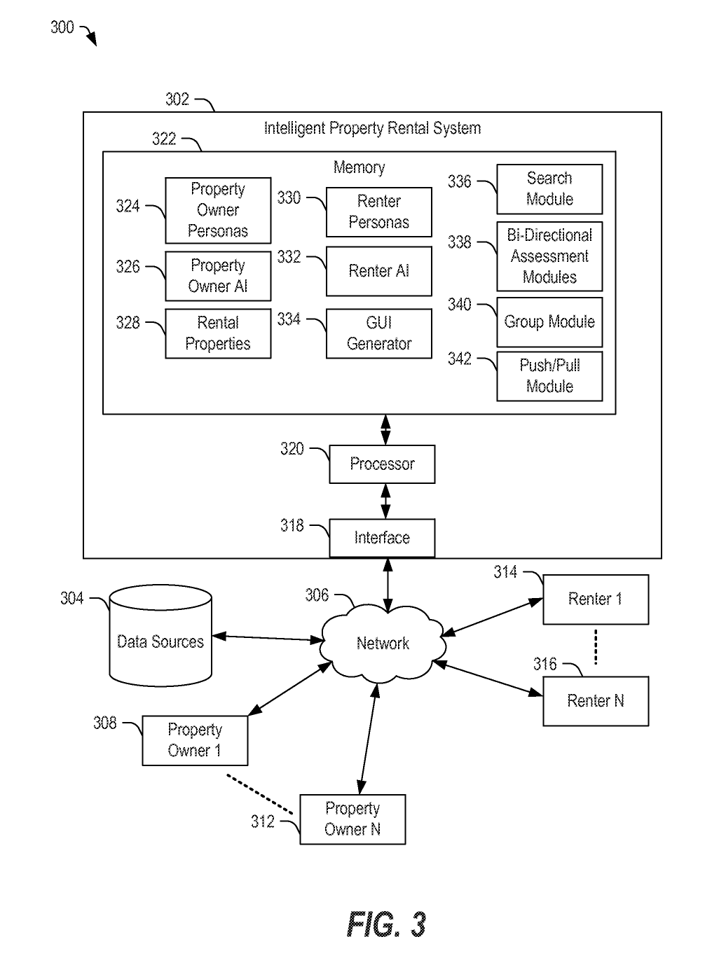

FIG. 3 is a block diagram of a system 300 including an intelligent property rental system 302, in accordance with certain embodiments of the present disclosure. The intelligent rental property system 302 may be configured to communicate with one or more data sources 304 (such as databases, websites, etc.) through a network 306 (such as the Internet). The intelligent rental property system 302 may also communicate with electronic devices of one or more property owners 308 and 312 (or property managers) and with electronic devices of one or more potential renters 314 and 316 (or existing renters) through the network 306. In some embodiments, the role of renter or owner/manager may depend on the context of the interaction, such that in a first context, the property owner/manager may interact with the system to manage property rental information, and in a second context may interact with the system to rent a property from another property owner/manager. In some embodiments, the system 300 may also initiate communications, proactively, to facilitate property rentals.

The intelligent rental property system 302 may include an interface 318 configured to couple to the network 306, and may include a processor 320 coupled to the interface 318. The processor 320 may include a processing circuit, such as a microcontroller unit (MCU), a field programmable gate array (FPGA), a general purpose processor, one or more processing units, or any combination thereof. The intelligent rental property system 302 may include a memory 322 couple to the processor 320. The memory 320 may store data and may store instructions that, when executed, cause the processor 320 to implement a property rental system as discussed above with respect to FIGS. 1 and 2.

The memory 322 may include data relating to property owner personas 324, rental properties 328, and renter personas 330. Further, the memory 322 may include a property owner AI 326 that, when executed, may cause the processor 320 to utilize the property owner personas 324, access data from data sources 304, and interact with other modules to perform operations as described above with respect to FIG. 2. The memory 322 may further include a renter AI 332 that, when executed, may cause the processor 320 to utilize the renter personas 330, access data from data sources 304, and interact with other modules to perform operations as described above with respect to FIG. 1. The memory 322 may further include a graphical user interface (GUI) generator 334 that, when executed, may cause the processor 320 to produce a user interface including data and including one or more user-selectable elements, such as buttons, links, text inputs, voice input, pull-down menus, or other elements accessible by a user to receive user input. The GUI generator 334 may produce an interface that may be rendered, for example, within a window of an Internet browser application, which may be executed by a processor of an electronic device, which may be associated with a property owner/manager 308 or 312 or which may be associated with a renter 314 or 316. In some embodiments, the GUI generator 334 may generate a search interface to receive search criteria and may generate a results interface to provide search results to a requester. In some embodiments, the GUI generator 334 may provide a push/pull interface to receive user input. In an example, the GUI generator 334 may provide an interface to ask the user to comment on an assessment of the user's needs automatically produced by the system 300.

The memory 322 may also include a search module 336 that, when executed, may cause the processor 320 to perform a search of one or more data sources 304 for various purposes, including identifying rental properties that meet criteria, determining information about potential renters or about property owners (such as from social media, reviews, etc.), determining property information, determining information about a property location (surrounding area, safety, nearby amenities, etc.), and so on. The memory 322 may further include one or more bi-directional assessment modules 338 that, when executed, may cause the processor 320 to assess one or more parameters associated with each rental property in a set of search results, to assess the risk associated with a potential renter, to assess risk associated with a particular property or property owner/manager, to assess multiple possible rental options, renter offers, and so on, and to assess other information. The bi-directional assessment modules 338 may assess and value the information provided by the user against other information. In some embodiments, the bi-directional assessment modules 338 may cause the processor 320 to make recommendations based on the available information. In some embodiments, the bi-directional assessment modules 338 may cause the processor 320 to automatically update (periodically, in response to a triggering event, or any combination thereof) recommendations as new information becomes available.

The memory 322 may include a group module 340 that, when executed, may cause the processor 320 to process a rental request involving a group of multiple individuals, families, etc. in order to coordinate renting of more than one rental property substantially simultaneously and with overlapping considerations. In some embodiments, the rental request may be to rent only one property for a group, where the property to be rented has to be the best, taking into account the divergent interests of the different group members. In some embodiments, the group module 340 may provide collective intelligence based on three sources: the user's initial search, other user's similar (or identical) searches, and yield management data. In an embodiment, a user may interact with the system to ask if there is a better search than his/her initial search. The system may automatically present the user with various “better” (or alternative) search options with an explanation of why each of the search options is better. In some embodiments, the group module 340 may cause the system to carry out searches against one or more of the “better” searches in parallel with a search performed based on the user's query. In some embodiments, the user may provide feedback related to one or more of the search results (or one or more of the searches). In an example, the group module 340 may cause the system to notify the user that a better search is available when the user conducts the search. For example, the system may provide a popup or other indicator stating “Yesterday evening someone else carried out a search that yielded a better result, so you should try searching in an evening.”

In some embodiments, the group module 340 may evaluate similar or identical searches performed by other users to find better results for the user than the search the user would have carried out. Group searches can present better results that may not have been presented based on the user's initial query. Further, some alternate results may achieve the same outcomes, in a way the user had not thought of when performing the initial search.

The memory 322 may further include a push/pull module 342 that, when executed, may cause the processor 320 to push a particular rental opportunity to a potential renter, to identify a potential renter to which a rental owner/manager may wish to make an offer or special offer, and so on. In some embodiments, the push/pull module 342 may allow a user to push a request to the intelligent property rental system 302. In an example, the user may push a request indicating parameters for a property rental the user wants (e.g., at least two bedrooms, on the beach, etc.). The push/pull module 342 may operate in conjunction with the GUI generator 334 to provide an interface through which the user may enter such information (in free form text, via check boxes and other selectable elements, or any combination thereof). The user may also utilize the user interface to specify that the request be pushed to “all property owners meeting the specifications”. In some embodiments, the request may be posted to an electronic bulletin board, which may be accessible by property owners, and the request may stay accessible on the bulletin board waiting for owners to search. In some embodiments, a property owner may interact with the push/pull module 342 to configure his/her settings to be notified of any request that meets the specifications of the rental property or that partially meets such specifications. The property owner may then configure his settings to provide a notification or to automatically initiate communication with the potential renter to facilitate the property rental process.

In some embodiments, the intelligent property rental system 302 may communicate a GUI to a device, such as a device associated with a potential renter. The GUI may include a text input, voice input, check boxes, pull-down menus, radio buttons, or other input elements through which a user may communicate one or more preferences and communicate a rental request. In some embodiments, a rental request may include search parameters for searching one or more data sources 304 to identify properties for rent that may satisfy the search criteria. In response to receiving the rental request, the processor 320 may execute the renter AI 332 and may identify one or more renter personas associated with the request. In some embodiments, the renter persona may be determined based on user login information. In some embodiments, the renter persona may be determined based on parameters of the request. The renter AI 332 may cause the processor 332 to execute the search module to identify a plurality of rental properties that meet the request. The plurality of rental properties may be identified from different data sources, including data sources from competing companies. The renter AI 332 may process the plurality of rental properties according to the one or more renter personas 330 to identify rental properties that not only meet the search criteria but that correspond to the persona information. In an example, if the persona corresponds to a family persona (indicating that the potential renter is looking for a rental property that may work for his or her family, such as a spouse and one or more kids), a one bedroom rental in an unsafe neighborhood may be undesirable, or a rental with a pool may be favored (or disfavored) relative to a rental next to a park. Such preferences may be determined from previous decisions, noise, indicators or actions made by a user associated with the particular persona. The renter AI 332 may further interact with the GUI generator 334 to present or highlight selected ones of the plurality of rental properties. In some embodiments, the GUI may include recommendations or advice regarding the selected properties. In some embodiments, the GUI may include a first option that may be selected by a user to empower the renter AI 332 to communicate with the property owner/renter to confirm availability of the rental property. In some embodiments, this confirmation can be performed proactively without user input. The GUI may further include a second option accessible by a user to empower the renter AI 332 to negotiate a price or one or more upgrade options that may be different from that included in the rental property listing. In some embodiments, the system 300 may proactively negotiate the price or the one or more upgrade options. In some embodiments, the system 300 may make suggestions to the renter to assist in negotiating a price including, in some instances, providing an indication of the likelihood of success in making a particular offer.

In some embodiments, the intelligent property rental system 302 may communicate a GUI to a device, such as a device associated with a property owner/manager. The GUI may include a text input, voice input, check boxes, pull-down menus, radio buttons, or other input elements through which a user may communicate one or more preferences and communicate rental information. Such rental information may include review information associated with a particular renter, rental information indicating that a particular rental property is available or unavailable, and so on. In some embodiments, the GUI may include information about multiple rental offers, about the potential renters, about “near misses” where search criteria didn't select a particular property, where a user went to book and didn't and so on.

In some embodiments, the GUI may include one or more options selectable by a user, such as a property owner/manager, to adjust the rental price or to add upgrades to a particular offer and to push the offer to a potential renter. In an example, the manager/owner may lower the price or include a gift certificate to a local restaurant, for example, to sweeten an offer and may interact with the GUI to present the change to a potential renter. In some embodiments, the offer may be made for a rental property that was not within the user's search results, in part, because the price was higher than that specified by the potential renter. In some embodiments, the offer was part of the potential renter's search results. In some embodiments, the intelligent rental property system 302 may insert an indicator within a GUI provided to the potential renter indicating the change or presenting the “pushed” offer or suggesting “make an offer”.

In some embodiments, the property owner AI 326 and the renter AI 332 may be executed by the processor 320 to initiate a communications link to facilitate negotiations between a potential renter and a property owner. In some embodiments, the communications link may be opened by interacting with a user-selectable element (such as a link or button) within a GUI. The GUI may cause a chat session or other link to be opened to facilitate negotiations, such as an instant message or other chat link, a bi-directional voice communication, or an electronic message exchange to facilitate such negotiations. In some embodiments, the intelligent property rental system may host a session during which the potential renter and the property owner/manager may communicate in real time or near real time via a secure communication channel, such as a chat session or other messaging session to allow the property owner/manager and the potential renter to negotiate a rental. In some embodiments, the system may proactively negotiate the rental deal from one or both perspectives, using personas to manage the negotiations. Such automated negotiations may be conducted for multiple properties, multiple renters, multiple property owners, or any combination thereof.

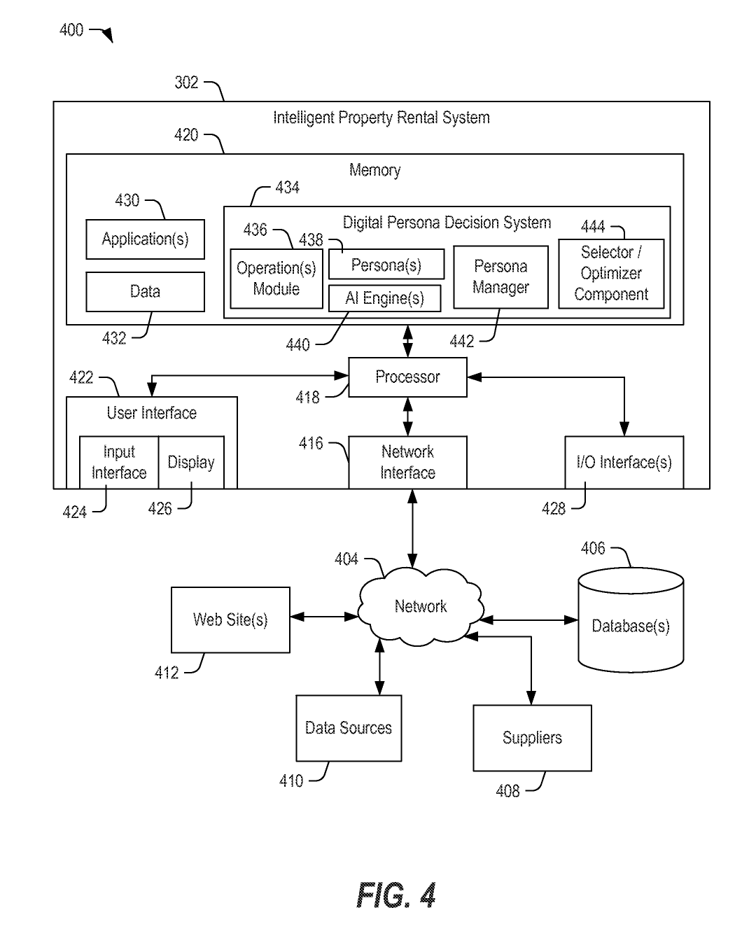

FIG. 4 is a block diagram of a system 400 including an intelligent property rental system, in accordance with certain embodiments of the present disclosure. The system 400 includes an intelligent property rental system 302 that may be configured to communicate with various devices and systems through a network 404, such as the Internet. In certain embodiments, the intelligent property rental system 302 may communicate via the network 404 with one or more databases 406, one or more suppliers 408, one or more other data sources 410, one or more web sites 412, other data sources, or any combination thereof.

The intelligent property rental system 302 may include a network interface 416 configured to communicate with the network 404. The intelligent property rental system 302 may also include a processor 418 coupled to the network interface 416, to a user interface 422, to a memory 412, and to an input/output (I/O) interface 428. In some embodiments, the user interface 422 may include a display interface configured to couple to a display device and an interface (such as a Universal Serial Bus port) configured to couple to a keyboard, a mouse, or another input device to receive user input. In certain embodiments, the user interface 422 may include the input interface 424 and a display 426, such as a touchscreen device.

The memory 420 may include a disc drive, a flash memory, cache memory, Random Access Memory (RAM), Read Only Memory (ROM), or any combination thereof. At least a portion of the memory 420 is a non-volatile memory configured to store data 432 and to store instructions that may be executed by processor 404 to perform a variety of functions and operations. The memory 420 may store one or more applications 430 and an intelligent property rental system 100. The intelligent property rental system 302 may include an operations module 436, personas 438, one or more artificial intelligence (AI) engines 440, a persona manager 442, and a selector/optimizer component 444.

The operations module 436, when executed, may cause the processor 418 to receive data at an input and, after processing with other aspects of the intelligent property rental system 302, provide an output including, for example, search results that have been ranked (scored), sorted, weighed individually or together, filtered, or otherwise processed with advice or justification according to a selected one of a plurality of personas 438. The personas 438 may be generated, modified, stored, and retrieved for use by the AI engines 440. Further, the personas 438 may include digital representations of individual consumers, groups of consumers, organizations, other entities, or any combination thereof.

In some embodiments, the AI engines 440 may include the property owner AI 326 and the renter AI 332 in FIG. 3. The AI engines 440 may include instructions that, when executed, cause the processor 418 to apply a selected persona or more than one selected persona of the personas 438 to received queries, to received results from queries, or any combination thereof. The AI engines 440 cause the processor 418 to process the data according to the selected persona(s) to rank the data, filter the data, or otherwise alter the data to provide a desired result that corresponds to a particular persona. The AI engines 440 may apply the selected persona to try to do what the user means rather than what the user says he or she means (i.e., to retrieve data corresponding to what the user intends to find). The AI engines 440 may also apply the selected persona to rank, sort, filter, or otherwise process received data. Additionally, the AI engines 440 may include at least one evolutionary function that, when executed, causes the AI engines 440 to process and update a persona over time, based on environmental factors, interactions of other personas, and so on. In particular, the AI engines 440 rely on experiential learning over time. In certain embodiments, the AI engines 440 assimilate numerous interactions by various personas, some of which may be similar to the selected persona, to learn experientially. The experiential learning process involves analyzing persona interactions (explicit or implicit) with the “universe” of available options to generalize trends and other information, which may be used to adjust the selected persona, other personas, etc., and to make recommendations and assist in decision-making.

In certain embodiments, the AI engines 440 may include collaborative filtering, clustering, classification, frequent pattern mining, outlier detection, noise reduction, and other functionality implemented via distributed or scalable machine-learning algorithms.

In certain embodiments, the AI engines 440 may include collaborative filtering, clustering, classification, frequent pattern mining, outlier detection, noise reduction, and other functionality implemented via systems that may be implemented using declarative rule-based systems, such as Drools or another rule-based management system. The AI engines 440 may be configured to process data (structured, unstructured, or semi-structured data) by filtering, clustering, classifying, weighing, correlating, performing any of the above-described functions, or otherwise processing the data.

It should be appreciated that a persona may operate in conjunction with the AI engines 440 independent of a query. In certain embodiments, a persona may respond to events, or to look out for needs and events where the persona may be required to do something or where the user should do or not do something in order to achieve a specific outcome. In certain embodiments, the persona may be configured to identify and present opportunities or solutions to a user proactively and to take steps to crystallize or achieve the opportunity or solution.

The intelligent property rental system 302 further includes a selector/optimizer component 444 that, when executed, causes the processor 418 to select between available results and to provide selected results to an output. In certain examples, the selector/optimizer component 444 may be presented with multiple multi-dimensional sets of search results, which may have been sorted, filtered, ranked, or otherwise processed by the AI engine 440 applying multiple selected personas 438. In an example, the results may be sorted, filtered, ranked, or otherwise processed using each of the multiple selected personas 438, providing search results ranked across multiple dimensions according to each of the personas, and the selector/optimizer component 444 may select one of the sets of ranked search results for providing as an output and offer justification for what is selected. In certain embodiments, the selector/optimizer component 444 may operate on opportunities, problems, outcomes, and event analysis in response to experiences and activities in the user's life and independent of any user query.

In certain embodiments, the selector/optimizer component 444 may select between the sets of search results based on data associated with a requesting device. In certain embodiments, the selector/optimizer component 444 may be configured to select a “best” representation of the results according to the available information about the user as represented by his/her persona at that point in time. In certain embodiments, the selector/optimizer component 444 may select a “best” representation of opportunities, problems, outcomes, and event analysis in response to experiences and activities in the user's life and independent of any user query, proactively providing a best representation of the possibilities according to the available information about the user as represented by his/her persona at that point in time.

In some embodiments, multiple digital personas may be engaged in making a decision when faced with varied options. In certain embodiments, the intelligent property rental system 302 may implement a set of digital personas that compete among themselves to resolve a problem in order to achieve a solution that best mediates the interests of the user of the digital personas. In an example, the problem may be a search request. By allowing the multiple digital personas to impact the search and the processing of the results, the intelligent property rental system 302 may produce multiple, varied result options, which can be compared and optionally processed by the selector/optimizer component 444. In some embodiments, the system 302 may take into account predictive search as well, further expanding the rental options. In certain embodiments, the selector/optimizer component 444 may select between the competing results or selectively combine results from the competing results. The intelligent property rental system 302 thereby may achieve optimal results for that user.

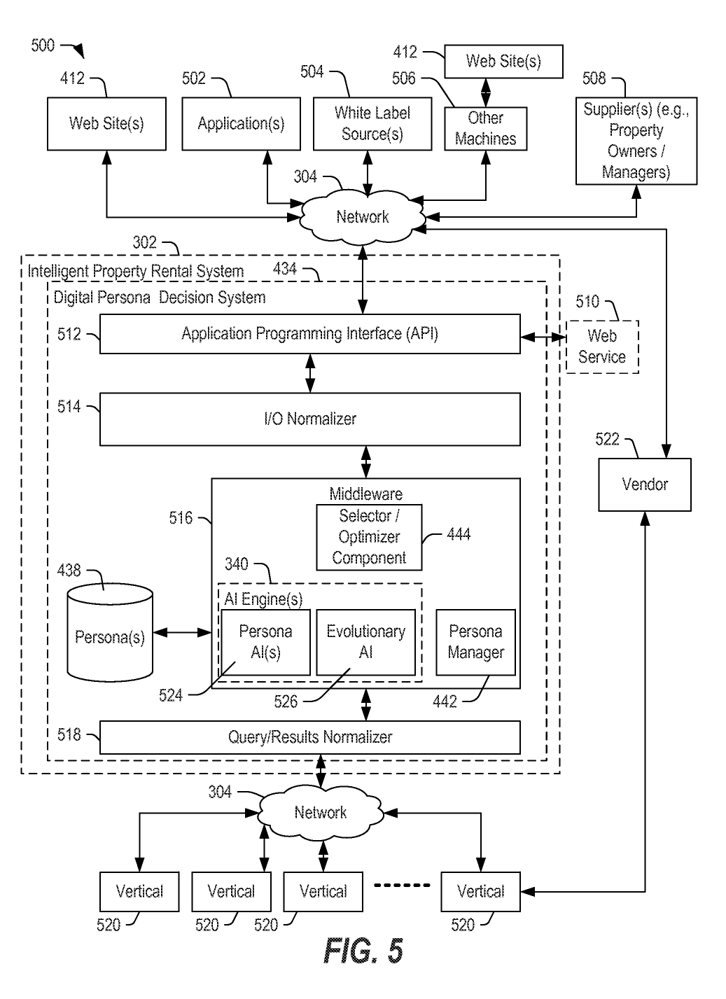

In certain embodiments, data from requesting devices and data from data sources may vary widely from source to source, in terms of content, organization and so on. To effectively process data from multiple requesting sources and from multiple data sources, the intelligent property rental system 302 may normalize the data and may operate on the data using AI engines 440 to produce queries directed to what the user really wants as opposed to relying solely on the keywords entered by the user. In certain embodiments, the intelligent property rental system 302 may normalize the structured data (such as database data, labeled data, or preprocessed data), unstructured data (such as text documents and other text) and partly structured data (such as extensible markup language (XML) code, and so on). The computing system may translate such text, including the key words, into a homogenous language that may be integrated together to form a comprehensive blueprint of opportunities, solutions to problems, etc. In certain embodiments, the data may be normalized by extracting the data, transforming the data into a format suitable for a table, and loading the data into a table, where the table provides a temporary staging area for the data prior to further analysis and processing. One possible expanded view of the digital persona decision system is described herein with respect to FIG. 5.

FIG. 5 is a block diagram of a system 500 including an intelligent property rental system 302, in accordance with certain embodiments of the present disclosure. The system 500 includes the intelligent property rental system 302, which may be configured to communicate with web sites 412, applications 502, white label sources 504 (i.e., private label applications or services), other machines 506, a web site 412 through one of the other machines 506, other businesses 508, vendors 522, or any combination thereof, through a network 304. Additionally, the intelligent property rental system 302 may be coupled to one or more verticals 520 through the network 404. The term “vertical” may refer to a particular market sector, such as travel, financial, healthcare, real estate, property rentals, entertainment, education, military, retail, grocery and produce, employment, etc. Each of the verticals, identified by 520, may include a plurality of websites, businesses, etc. that service that particular sector. Though each of the verticals 520 is depicted as distinct entities, it should be understood that the verticals 520 may overlap one another and that a business entity or website may cross multiple verticals, or sub-categories within one or more verticals (sub-verticals).

The one or more verticals 520 may include a rental property vertical. The rental property vertical 520 may include residential rentals and vacation rentals for both short term (a few days) and long term (weeks, months, years, etc.). Further, though the discussion has largely focused on vacation rentals and property rentals, the system 500 may also be used with other types of property transactions, such as office rentals, and the like.

In the illustrated example of FIG. 5, the intelligent property rental system 302 is depicted as being coupled to two different networks, both of which are labeled 304. It should be understood that the networks 304, though separated, may be understood to be the same.

The intelligent property rental system 302 may include an application programming interface (API) 512, which may be coupled to the web sites 412, applications 502, white label sources 504, other machines 506, other businesses 508, web services 510, vendors 522, or any combination thereof. The web services 510 may be part of the intelligent property rental system 302 or may be associated with another device or system. The API 512 coordinates interactions between the intelligent property rental system 302 and external components, devices, applications, etc. Further, the API 512 may receive data from the network 304 and may provide the data to an input/output (I/O) normalizer 514.

The I/O normalizer 514 translates received data into a format suitable for processing by the middleware 516. In certain embodiments, the I/O normalizer 514 may perform extract, transform, and load (ETL) functions using artificial intelligence. In particular, the I/O normalizer 514 may extract data from a received data stream, transform the data into appropriate formats (e.g., transform date information in a form of m/d/yy into a form mm/dd/yyyy), and load the data into a temporary table, which may be provided to the middleware 516. The normalization process may be performed automatically by a machine (the I/O normalizer) and may only utilize a minimal “mapping” effort with respect to placement of the data into the table.

The middleware 516 may include the selector/optimizer component 444, the AI engines 440, and the persona manager 442. The persona manager 442 may receive data from the I/O normalizer 514 and determine one or more personas from the personas 438 for use in connection with the received data. Additionally, the persona manager 442 may cause the processor to selectively execute one or more persona AI engines 524 (which applies selected personas to data). The one or more AI engines 524 may include the property owner/manager AI 326 and the renter AI 332.

In some embodiments, the persona manager 442 may cause the processor to selectively execute an evolutionary AI engine 526 (which may initiate changes in selected personas based on user interactions with the data, based on information derived from other personas, based on information derived from the “universe” of options, or any combination thereof). The intelligent property rental system 302 may further include a query/results normalizer 518, which may normalize a query, data, other information, or any combination thereof into data formatted for a particular one of the verticals 520.

In certain embodiments, a user may initiate a query via the web site 412, a mobile application, a business-to-business (B2B) connection, or any other front end device or system, and the query may be submitted to the intelligent property rental system 302. The API 512 receives the query and provides the query to the I/O normalizer 514. The I/O normalizer 514 processes the query into a suitable format for the middleware 516. The middleware 516 may select one or more personas from personas 438 using the persona manager 442 based on login information included with the query, based on the query itself, based on other information, or any combination thereof. The middleware 516 may also apply the selected persona(s) to the query using the persona AI engine 524 to perform query expansion, apply modifications or corrections to the query, and add constraints and refinements to the queries according to a selected persona to customize the query to the selected persona. The middleware 516 may provide the processed query to the query/results normalizer 518, which may normalize the processed query into suitable formats for one or more data sources associated with a particular vertical 520. The query/results normalizer 518 may then provide the processed and normalized query to one or more data sources associated with the vertical 520. In some embodiments, the system 500 may initiate a query, such as where the system 500 determines that a different search is more appropriate than that submitted by the user. In an example, a user may search for a hotel room, but the system 500 may determine that the user would be better served by renting a holiday home rental property based on a combination of factors including price, family considerations, size of the property, location, amenities, etc. In some embodiments, the system may take into account past rental history to provide a reminder (recommendation) to the potential renter (months in advance) to make rental arrangements several months in advance so that the renter can find better pricing than if he or she rented at the last minute.

In certain embodiments, the options/solutions may be processed on a computing device such as a server and the results may be provided to a remote device, such as a laptop computer, a tablet computer, a desktop computer, a smart phone, or another data processing device. In certain embodiments, the intelligent property rental system 302 may be implemented on a smart phone or other computing device, which may present options/solutions to a display.

In response to the processed and normalized query, the intelligent property rental system 302 may receive results associated with the particular vertical. The query/results normalizer 518 may receive results from multiple data sources and may extract, transform, and load the results into one or more temporary tables, which may be passed to the middleware 516. The persona AI engine 524 may apply one or more selected personas from personas 438 to the results to produce one or more processed results. The processed results may be ranked, sorted, weighed, filtered, processed, or any combination thereof according to each of the one or more selected personas, potentially producing multiple multi-dimensional sets of processed results, which may be provided to the selector/optimizer component 444. The selector/optimizer component 444 may select one of the sets of processed results and may provide the selected one of the sets to the I/O normalizer with advice/justification 514, which may extract, transform, and load the data from the selected one of the sets of processed results into a format suitable for the API 512 to provide the results to a destination. The destination may be a device, an application, a web interface, etc.

When introduced with a problem, the I/O normalizer 514 may normalize the input and provide the input to the middleware 516. The middleware 516 can deliver specific facts and circumstances at hand to a persona AI engine 524 with selected digital personas from the personas 438, where each of these selected digital personas offers a potential solution in accordance with the following process: (1) the intelligent property rental system 302 can produce a solution aligned with specific preferences and restrictions pre-established by the user within each digital persona; (2) the system can conduct a competition among the digital personas to determine optimal solutions for the user in the context of the specific facts and circumstances of each user request; and (3) the system can thereby resolve the problem presented by the user of the digital persona. The selected digital personas may be applied to the persona AI engine 524 to customize the persona AI engine 524, which customized AI may process the input data to adjust keywords, apply restrictions and query enhancements, and produce queries that are aligned with the specific preferences and restrictions associated with that particular persona. Such preferences and restrictions may be configured by a user, may be learned over time from explicit and implicit feedback from the user's interactions, may be inferred from interactions of various personas, from other users, or any combination thereof. The queries produced by the persona AI engine 524 based on each of the selected personas may be normalized by query/result normalizer 518 and may be sent to one or more data sources. Each of the normalized queries produces results, and the results from each of the queries provides a basis for competition among the digital personas, which competition may be resolved by the selector/optimizer component 444 to determine optimal solutions for the particular problem. It should be appreciated that, for both the potential renter and the property owner/manager, the process may be continuous and may evolve. The results may be normalized by query/result normalizer 518 and provided (together with the associated persona) to the selector/optimizer component 444, which may select between the results or which may selectively combine the results from one or more of the sets of results to produce a set of search results, which may then be provided to normalizer 514 for normalization before transmission to a device. Throughout the process, the intelligent property rental system 302 can intelligently track, collate, analyze, and record each solution, monitor user feedback (explicit and implicit), and thereby continuously learn the habits and behaviors of the user of the digital personas. The learned habits and behaviors may be used by the evolutionary AI engine 526 to refine the digital persona(s) over time to achieve ever-more-effective results.

In certain embodiments, the intelligent property rental system 302 uses unsupervised “deep” learning to learn about available options within the universe of options, to observe and learn from user interactions with that universe, and to refine a baseline persona associated with a particular category of users for a vertical 520 within the universe of options. The evolutionary AI engine 526 may modify the default or baseline personas within personas 438 based on such deep learning. Other personas (i.e., those representing individuals, corporations, etc.) may be understood as differences or deviations from the baseline persona for that particular category of entity. In an example, a persona associated with a user named Terry may be understood as a difference or delta between Terry's preferences, selections, and restrictions and those of the baseline persona. Since the baseline persona may evolve over time, twenty-four hours per day, based on interactions associated with every other persona in the system or based on interactions with the digital universe, Terry's persona benefits from the deep learning of the system without changing any parameters specific to Terry's persona. Thus, the intelligent property rental system 302 evolves the individual's persona over time as its understanding of the universe of options evolves, and without losing the individuality of the user's persona. In particular, the persona AI engine 524 can selectively weight the deltas of the user's persona relative to the baseline persona in order to dampen the impact of evolution of the baseline persona, particularly if there is an extended period of time between visits by the user.

In certain embodiments, the intelligent property rental system 302 can implement searches (using the AI engines 524 and 526 and the personas 438) to fundamentally alter the user's experience. By utilizing personas, the intelligent property rental system 302 may provide results, options, etc. that are tailored to the particular user at that particular moment in time, changing the experience from an episodic, non-experiential, and non-predictive experience to one that is tuned to the particular user through experiential learning. The user's persona in conjunction with the persona AI engine 524 makes it possible to provide an experience that is tailored to the particular user, predicting and providing what the user really wants and anticipating what the user may truly need, even if the user is not aware of those needs. Further, the persona AI engine 524 may be configured to help the user achieve his/her overall objective including assisting with various steps to make sure that the particular objectives of the user are met to whatever extent desired by the user, instead of simply presenting search results.

In certain embodiments, the user's persona can operate in conjunction with the persona AI engine 524 to provide a dynamic personalized intelligent search that yields the “best” for the user, with the user being split into the very essence of the user at that point in time taking into account what the user says he/she wants, what the user actually wants, where the user is, when the user is, what people are doing that the user trusts (such as friends, family, experts, etc.). Instead of assuming that there is only one user (which is what most people, websites, companies, etc. do), the system can recognize that a user may act differently and may make different types of decisions based on the context within which the decision is being made (e.g., time of day, individual's decision-making role (individual, employee, father, etc.), the date and its correspondence to upcoming events (birthdays, holidays, anniversaries, etc.), how the user is being impacted by the universe, and other context-based information.

In certain embodiments, the intelligent property rental system 302 can be configured to look for “better” options/solutions, with the concept of “better” encompassing one or more factors (including a large number of factors), defined by the user, suggested by the system, or both. In certain embodiments, the intelligent property rental system 302 may be configured continuously to look for “better” proactively without being asked or based on a user action. In some embodiments, the “better” option may include different product types (e.g., hotel, bed and breakfast, home rental, etc.) and unexpected results. The unexpected results might include options that, if they were originally asked of the potential renter, might not have been thought of as being “better” options, but that actually are better options for the user.

In certain embodiments, the intelligent property rental system 302 may communicate with suppliers 508 (such as property owners/managers), with websites 412, or with other data sources (such as property rental databases). A supplier 508 may utilize data from the system to learn that there is a demand for his/her product or a similar product. Further, the supplier 302 may also learn that the demand for the product or similar product exists at conditions similar to those at which the product was made available to consumers, but not identical to those conditions (i.e., different price, different features, different dates of availability, etc.). The supplier 508 may also determine information about the person or persons requesting the product to determine the value of the person seeking the product, taking into account a broad value (category A) or narrow sub-values. In some embodiments, the system 500 may allow the supplier 508 to see what other suppliers are offering. The supplier 508 may adjust his offerings (behavior) based on other suppliers. Alternatively, the supplier 508 may empower the system 500 to proactively adjust the offerings of the supplier 508 based on other comparable offerings from other suppliers. In an example, the system 500 may be empowered to adjust (raise or lower) the price of a rental property offered by the supplier 508 based on the prices of other suppliers, the number of available properties in the area, other factors, or any combination thereof.

In a particular example, a first user may be a window shopper, always asking for “better”. The first user may say that he/she is interested in certain types of properties, but for this first user it's really all about price. A second user may purchase about 30% of the time. The second user may be a total cheapskate, but may be an executive platinum with various airlines suggesting he fits a certain desirable demographic. Further, the second user may be followed by many as a trendsetter, meaning that he/she starts and leads trends. A third user may purchase nearly all the time, but has no loyalty to any particular property owner/manager, and has little or no price sensitivity. The third user may be an impulse shopper. The intelligent property rental system 302 may dynamically determine the status of the first user, the second user, and the third user, which status changes over time. In certain embodiments, the intelligent property rental system 302 may understand that the second user is of particular interest to the supplier who wants to get long term repeat customers with that demographic. Further, the intelligent property rental system 302 may recognize that the second user is also of particular interest to another supplier who wants to steal the second user because the second user is the “right sort of customer.”

Thus, on the supplier side, the request for “better” or the suggestion of a desire for “better” (as a request may not actually have been made by the user) or the system's belief that “better” exists can yield a competition between suppliers 508 either for that user's business. That competition may occur on the basis requested, such as $20 less than originally offered, or on different grounds, such as the same price as originally offered but with a free upgrade; or in the hotel context the same price as originally offered plus bonus points; requested $20 cheaper but only able to offer $5 cheaper but will include breakfast; and so on. The response to the request for better or the suggestion of a “desire for better” or the system instigating a search for better (or the system being aware of better and proactively suggesting it) can in turn yield behavior from the persona AI engine 524 (implementing the persona) on the consumer side, which may accept one of the offers, negotiate, specify a different “better” request, etc. This can be done with any type of inventory, upsell or cross-sell and could be done with any virtual product. In some embodiments, the persona AI engine 524 (implementing the persona) on the consumer side may accept one of the offers, negotiate, specify particular requests, and so on, related to a plurality of property rental options. In certain embodiments, the interactive nature of the system allows for a potentially infinite number of user/system communications and system/supplier communications and allows for multiple, potentially simultaneous conversations to provide rental options or other types of options (e.g., discount options, upgrade options, and so on) for the user.

The intelligent property rental system 302 or platform may be configured to assess a “true” value of a product by itself, or on behalf of an entity (for example, a user, a supplier, a group, an organization, or any combination thereof) on a real-time basis. “Value” is currently perceived as something that is mainly centered on a monetary amount, but the intelligent property rental system 302 applies a multi-dimensional assessment process that determines multiple values for a particular product, based on decisions made by other personas, expiration of the product, time, date, price, quantity, other factors, or any combination thereof. The combination of the multiple values provides an assessed value or determined value, which can be used to determine a “best” option, such as the option that provides a maximum “bang for the buck” for the entity.

In an example, in a first layer, the intelligent property rental system 302 may perform a financial assessment (monetizable cost) of a particular option as compared to another available option. For example, a first rental property may cost $100 per night while a second rental property may cost $120. In a second layer, the intelligent property rental system 302 may determine information about the first and second rental properties, such as information about the safety of the area in which the property is located, information about the property owner/renter (i.e., reviews, etc.), information about local amenities, and so on, with such information being assessed and valued. The intelligent property rental system 302 may not evaluate better or worse during this process, but may just determine that the rental properties have different values with respect to different parameters.

The intelligent property rental system 302, in a third layer, determines the perceived value of the product for a given entity. For example, for user X, access to a pool is not important, but access to local restaurants is. For another user, user Y, timing of the stay is most important. The value specific to an entity may reflect the entity's likes and dislikes, both as specified by the user or as learned by the intelligent property rental system 302, even when the latter contradicts the former. The intelligent property rental system 302 may, in a fourth layer, determine changes in the universe or universe of options that may, in the future, change the public perception or the entity perception. The intelligent property rental system 302 may combine each of these values to determine a “real” value of the product. In certain embodiments, the “real” value may be calculated as a monetizable cost divided by the real value for the user, which is the publicly accepted value, the perceived value for the user, and changes in the universe or universe of options that may affect the publicly accepted value or the perceived value (or both). For example, a property rental for $100 per night in Pensacola Beach, Fla. may have a lower “real” value than $150 property rental in Gulf Breeze, Fla., at least at specific points in time or for specific users.

For the supplier 508, the intelligent property rental system 302 may provide real-time demand insights and the ability to quantify information, such as who the insights come from, under what circumstances the insights were generated, and so on. Further, the intelligent property rental system 302 may be configured to forecast and to impact future demand by taking actions that impact public perception, entity perception, or both. The actions taken can lead to a difference between the determined “true” value and the perceived value, and it may take a period of time before one catches up to the other. In some embodiments, the system 500 can create a market in any form or at any point to increase efficiency and increase transactions. In some embodiments, the middleware 516 may utilize the evolutionary AI 526 to cause one or more of the personas 438 to evolve and to learn. In some embodiments, the system 500 can create multiple markets and monitor performance against each other.

In certain embodiments, a supplier or another involved entity may “play” with “what if” scenarios, by adjusting parameters in the intelligent property rental system 302, in order to research and identify a “real” value of current product offerings or of virtual or future products. For example, an entity such as a supplier may add or remove certain characteristics of a product and may assess the impact of the change to the “real” value. In a particular example, a supplier can “design” products that are more cost efficient but still yield their desired value. In an example, a property owner/manager can check the value of a rental property (or room in a hotel, for example) at a certain time and can add different non-monetary items to the offering, such as early check-in, an upgrade, etc. In response to such additions, the supplier can identify the resulting increase or decrease in a product's “real” value. In an example, the supplier can then use the intelligent property rental system 302 to forecast the impact of change of value on the user's willingness to rent the property. In this way, the intelligent property rental system 302 allows suppliers to tailor their rental property offerings. As mentioned above, in some embodiments, the intelligent property rental system 302 allows suppliers to have visibility into what other suppliers are doing (offering) and the impact that such actions (offerings) had with respect to prospective renters.

In certain embodiments, the intelligent property rental system 302 may search experientially, reflecting the user's needs (actual and potential, expressed and unexpressed) rather than simply responding to the search request. In an example, the user's persona, taking into account the scheduled travel plans of the user, may proactively search for rental properties near a particular conference, near to known friends or business contacts, and so on. Further, the user's persona may cause the intelligent property rental system 302 to search for properties that are close to the parameters specified by the potential renter. Additionally, the user's persona may determine that the user has a family member in the vicinity of his/her travels and may proactively search and selectively provide travel options to the user that would allow the user to visit his/her family member during the travel. In certain embodiments, the persona may act as the user's personal assistant, taking into account the user's past, present and infinity of futures to proactively present options to the user. Further, the persona may interpret user actions and inactions in response to presenting such options and may update itself automatically without the need for new searches and without the need for the user to manually configure preferences.

In some embodiments, a user may purchase, adopt, or request a persona associated with another person, such as a celebrity, an expert, a friend, etc. The selected persona may be used to prioritize available rental options.

In some embodiments, the persona AI 524 may interact with a user via a GUI to receive authorization to negotiate with a property owner/manager on behalf of the potential renter. In some embodiments, the persona AI 524, in response to receiving authorization from a potential renter, may automatically send one or more electronic messages to one or more property owners in order to verify whether the property is available, to negotiate prices, and so on. In some embodiments, the persona AI may automatically send one or more electronic messages to one or more property owners in order to verify whether the property is available, to negotiate prices, and so on, proactively and based on previous situations.

In certain embodiments, the persona in conjunction with the persona AI engine 524 may have the ability to understand a non-standard search request that incorporates a multiplicity of structured, unstructured and partly structured data, where, under ordinary circumstances, it would not be clear what is actually being searched for. In certain embodiments, the persona may utilize previously provided information, e.g., that the user always chooses child friendly hotels when the user searches for hotels, to make assumptions and to adjust the user's search to provide child friendly results.

Further, in certain embodiments, the persona in conjunction with the persona AI engine 524 may perform a predictive search or take a predictive action in the case of an upcoming experience. The term “predictive search” refers to a search that the persona AI engine 524 determines is a better search to carry out, which search can be similar to or based on searches carried out by others. In some embodiments, the better search can be based on an evaluation of the results achieved from searches by other users, based on the AI engine's knowledge of yield management, based on other information, or any combination thereof. In some embodiments, the better searches can be recommended at the time of search, at another time, or both. Further, the better results from these searches can be shown or can be omitted unless the user requests those results.

For example, the persona may be aware of a personal milestone (such as the user turning 40 years old), and may make one or more recommendations to the user based on such awareness. In certain embodiments, the persona in conjunction with the AI engines 440 may be configured to analyze decisions from a plurality of personas, producing a group intelligence that may be used to identify a trend at an early point, before anyone else would consider it a trend. The intelligent property rental system 302 may detect variations in decision-making, which may represent a very early trend or series of trends and make recommendations to guide the user toward the trend, providing “expert” wisdom and trendy outcomes before such trends are recognized as “expert”. Understanding that other systems may recognize the beginnings of such a trend as noise, the personas and the intelligent property rental system 302 take the smallest noises (and sometimes the absence of noise where it would otherwise be expected) and learn from it for the personas and for the users. Such predictive analysis allows the personas to make recommendations to trendy selections before such selections become well-known to others outside of the intelligent property rental system 302. For example, when a restaurant is trending up based on reviews and known traffic, the persona may recommend the restaurant to a user, even before local media or others in the user's circle of friends become aware of the new “hot” spot. In certain embodiments, the intelligent property rental system 302 may recognize a particular persona as being an “expert” based on his/her “successes”, where “success” may be defined based on a “purchase” or some other factor. Such experts may be recognized within the intelligent property rental system 302 based on such information, whether or not that person may be an expert elsewhere. In certain embodiments, the persona may be a “celebrity” or “expert” persona, such as an Einstein persona, which could be an expert persona with respect to a certain subject area. Further, the intelligent property rental system 302 may recognize a “trendsetter” based on the user's ability to make choices, over time, that may be unpopular at the time the choice is made, but that become popular shortly after the trendsetter's decision was made. That persona, over time, may be identified as a trendsetter.

The normalizers 514 and 518 of intelligent property rental system 302 may translate data from any source (in any format) to be useful and valuable to all users. The persona AI 524 may utilize such data to make recommendations to a user.

In certain embodiments, the intelligent property rental system 302 described herein may utilize personas to provide group intelligence by combining users' experiences, choices and results (through groups of personas) to apply new knowledge to future searches. In certain embodiments, the intelligent property rental system 302 may combine the multiple personas to produce one combined persona, which may provide solutions based on group intelligence. In certain embodiments, the intelligent property rental system 302 may utilize the multiple personas to generate multiple solutions, which may be selectively provided to the user based on selections made by the selector/optimizer 444. In some embodiments, searches by other users may yield “better” results, and the intelligent property rental system 302 may suggest better searches in response thereto.

In certain embodiments, the intelligent property rental system 302 described herein may utilize personas to apply social, family and relational status to decision-making processes. In an example, the persona may recognize the familial/relational status of a traveler without status (i.e., a spouse, an employer, etc.) who has a direct influence on the non-traveling status holder (i.e., Platinum customer/member), and may assist in making informed decisions to ensure a positive experience for the traveler.

In certain embodiments, the intelligent property rental system 302 may maintain a digital persona library, and may offer users the opportunity to buy or rent a persona (such as an expert persona, a celebrity persona, and the like) to make decisions and “live” like an expert or celebrity. In certain embodiments, each persona may be compiled to a digital file that may be transferred to a user device for use with another persona-enabled system. In certain embodiments, each rented persona may be utilized as a digital representation via a proxy server that manages the client/site interactions.

In certain embodiments, the intelligent property rental system 302 described herein may utilize personas to provide a multi-field search adjustment in a single search. The persona may be used to adjust single or multiple fields (such as price, dates, location, etc.). The query results may dynamically reflect the changes. In certain embodiments, the intelligent property rental system 302 described herein may utilize personas to search for and cross-reference coupons, discounts and rebate offers to find the best combination of valid offers to maximize savings. In some embodiments, as the user changes each field in the same search, the interface may allow the user to select the best option or options from that set of purchase options. The user may then interact with the interface to initiate a comparison of one or more of the selected best options. In some embodiments, the intelligent property rental system 302 can do the same exercise and suggest different permutations to change and recommend the best option in each scenario and the best overall option.

In certain embodiments, the intelligent property rental system 302 described herein may utilize personas to dynamically analyze competitor prices and to create a differential and generate maximum revenue by making price adjustment recommendations to property owners/managers or by automatically making the adjustments. In certain embodiments, the intelligent property rental system 302 described herein may utilize personas and yield management data to provide a yield management engine that analyzes demand and makes recommendations to a supplier to increase value to targeted customers, such as by lowering a price, offering upgrades, and so on. In certain embodiments, the intelligent property rental system 302 described herein may utilize personas to provide group conflict resolution that finds solutions that fit multiple travelers' contrasting needs (status, currency, time, location, etc.).

In certain embodiments, the intelligent property rental system 302 described herein may utilize personas to provide a group brain, such as by combining personas. The group brain may be a combination of multiple digital personas working together to adapt and make decisions that appeal to a group. In certain embodiments, the intelligent property rental system 302 described herein may utilize personas to steal customers by providing a real-time continuous reverse bid opportunity that allows property owners/managers to offer better values to a ready-to-buy/rent customer, to recover (identify) transactions that would otherwise be lost, and to generate entirely new transactions (or to adjust offers made to the potential renter). Additionally, in certain embodiments, the systems described herein may utilize personas to provide language agnostic transactions that deliver real-time multi-lingual translation for transactions and user communication to facilitate transactions.

As described herein, personas can contain a vast amount of knowledge and power concerning a user, whether that user is a person, group, business, or other user. The value for certain personas may be very high. Thus, the systems and processes described herein can be implemented with the highest levels of digital security. For example, the personas may be authenticated to specific users, devices, groups, or other authentication entities. Further, the personas themselves may be encrypted any time they are stored or transmitted externally to an authenticated processor. Further, memory and processors storing or utilizing the personas may be hardened to prevent malicious intrusions and attacks. In the example of the intelligent property rental system 302, the personas may be encrypted before being stored to personas database 438 and all communications over networks 404 may be encrypted. Further, all information and data between the web services 510 may be encrypted.

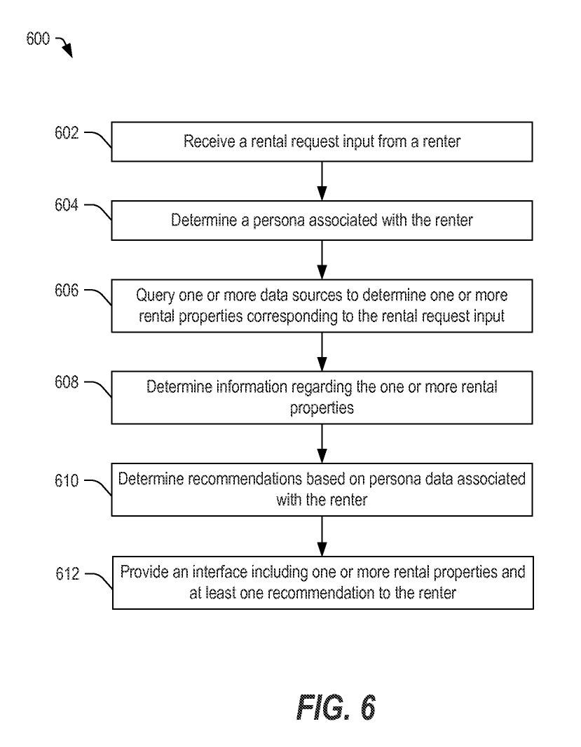

FIG. 6 is a flow diagram of a method 600 of providing a recommendation to a potential renter, in accordance with certain embodiments of the present disclosure. At 602, a rental request input is received from a renter. The rental request input may be received from a GUI rendered on a computing device of a user, such as a potential renter, and may be submitted via the GUI through a network to the intelligent property rental system 302.

Advancing to 604, the intelligent property rental system 302 may determine a persona associated with the renter. The persona may be determined based on log in credentials, based on a property request, based on other information (such as cookies, or other data), or any combination thereof. Continuing to 606, the intelligent property rental system 302 may query one or more data sources to determine one or more rental properties corresponding to the rental request input. The data sources may include one or more databases, websites, etc.

Proceeding to 608, the intelligent property rental system 302 may determine information regarding to the one or more rental properties. The intelligent property rental system 302 may also assess and value the respective information. The information may include reviews, information about the property owners/manager, information about the surrounding area of the rental property (e.g., crime information, etc.), information about the local schools, information about nearby amenities (such as stores, parks, restaurants, libraries, etc.). Continuing to 610, the intelligent property rental system 302 may determine recommendations based on persona data associated with the renter. In some embodiments, the intelligent property rental system 302 determines recommendations by generating or selecting recommendations based on persona data. The recommendations may also take into account the information determined regarding the one or more properties and the system may provide justification or advice for its recommendations. Advancing to 612, the method 600 may include providing an interface including one or more rental properties and at least one recommendation to the renter. In some embodiments, the interface may include advice, justification for prioritizing one option over another, other information, or any combination thereof. In some embodiments, the interface may be a graphical user interface including user-selectable options. In some embodiments, the one or more rental properties and the at least one recommendation may be provided to a device associated with a potential renter through a communications link, which may extend through a network such as the Internet.

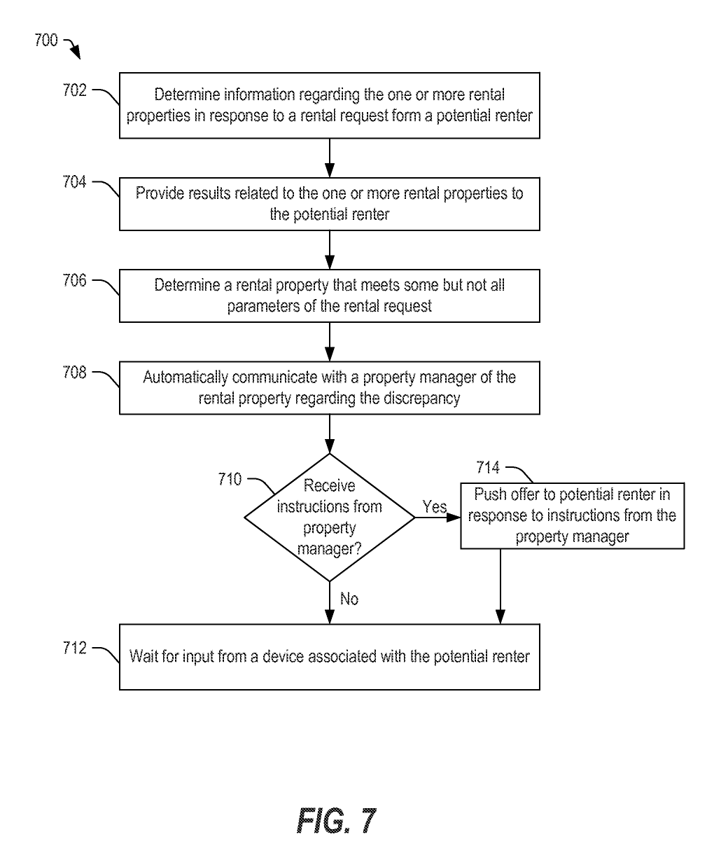

FIG. 7 is a flow diagram of a method 700 of pushing an offer to a potential renter, in accordance with certain embodiments of the present disclosure. At 702, information may be determined (identified) regarding the one or more rental properties in response to a rental request from a potential renter. The information may include reviews and other data about the property as assessed and valued. Continuing to 704, results related to the one or more rental properties may be provided to the potential renter. The results may include data about the one or more rental properties as well as the identified information and may include advice.

Advancing to 706, the intelligent property rental system may determine a rental property that meets some, but not all, of the parameters of the rental request. For example, a particular rental property may meet specific search criteria (e.g., number of bedrooms, pool access, etc.), but may have a per-night rental price that exceeds that specified in the rental request. Moving to 708, the intelligent property rental system may automatically communicate with a property manager (or owner) of the rental property regarding the discrepancy. In some embodiments, the property manager/owner may utilize the discrepancy information to adjust his or her offered rental price (to the potential renter) in order to have the intelligent rental property system present the particular rental property offer to the potential renter. The intelligent property rental system may facilitate completion of rental agreements between the potential renter and multiple property owners (on behalf of the renters) or between the property owner and multiple renters (on behalf of the property owner).

Continuing to 710, if instructions are not received from a property manager/owner, the method 700 may advance to 712 and the intelligent property rental system may wait for input from interactions with the GUI provided to the device of the potential renter. Otherwise, at 710, if instructions are received from a property manager (such as an adjusted offer), the method 700 may advance to 714 and the intelligent property rental system may push the offer to the potential renter in response to instructions from the property manager/owner. The method 700 may then advance to 712, and the intelligent property rental system may wait for input from interactions with the GUI provided to the device of the potential renter or provide advice on the property manager's response eg I think you can get him $25 lower a night.

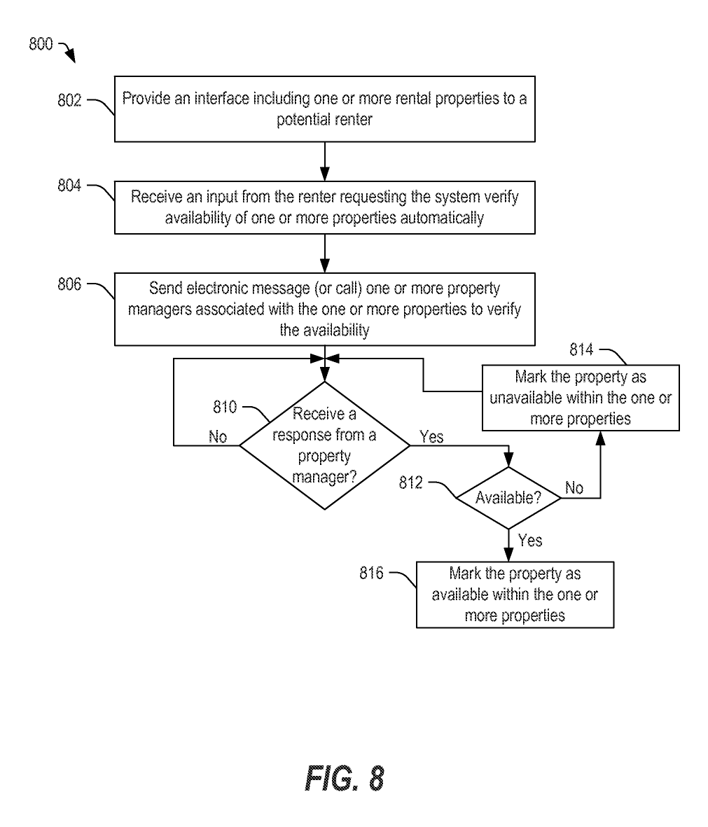

FIG. 8 is a flow diagram of a method 800 of automatically verifying availability of one or more rental properties, in accordance with certain embodiments of the present disclosure. At 802, the intelligent property rental system may provide an interface including one or more rental properties to a potential renter. The one or more rental properties may be identified based on a rental request received from a device associated with a potential renter. The interface may include one or more selectable elements, such as buttons, links, checkboxes, pulldown menus, radio buttons, voice input and the like. In some embodiments, the user may select one of the one or more rental properties to initiate a property rental process in order to complete the rental process. In some embodiments, the data sources from which the one or more rental properties are identified may have incomplete booking information, such that properties that seem to be available may have been rented, but the data sources have not been updated. The GUI may include an option to empower the intelligent property rental system to communicate with one or more of the property owners/managers of the one or more rental properties to verify their availability or the system can be set to always automatically verify availability of likely good choices before even showing them to the user.

Advancing to 804, the intelligent property rental system may receive an input from the renter requesting the system verify availability of the one or more properties automatically. Proceeding to 806, the intelligent property rental system may send an electronic message (or call) one or more property managers (or owners) associated with the one or more properties to verify their availability. In some embodiments, the intelligent property rental system may send the electronic messages to or call multiple property managers (or owners) substantially concurrently. In some embodiments, the electronic message (or call) may include email, SMS messages, push notifications, automated telephone calls using interactive voice response technology, other electronic communications, or any combination thereof.

Advancing to 810, if a response is not received from a property manager (or owner), the method 800 returns to 810 and continues to wait for a response. At 810, if a response is received, the method 800 advances to 812. At 812, if the property is not available, the method 800 continues to 814 and the intelligent property rental system marks the property as unavailable within the one or more properties. At 812, if the property is available, the method 800 advances to 816 and marks the property as available within the one or more properties. In some embodiments, the intelligent property rental system may follow up for a response. If a property is unavailable, the intelligent property rental system can check to see if nearby dates are available (for example, if the user has indicated that the dates are flexible) or if the system has seen from the user's previous behavior that the user seems to have flexibility in dates. In some embodiments, the intelligent property rental system may determine if the property is available for part or most of the requested dates if the renter is flexible.

In some embodiments, if multiple electronic messages were sent, the method 800 may return to 810 and process a next response (if received). Alternatively, the method 800 may wait at 810 until responses are received for each of the electronic messages or until a period of time has elapsed.

In some embodiments, in addition to verification of the availability of a particular property, the GUI may include a user-selectable option accessible by a user to selectively authorize the intelligent property rental system to negotiate the price or to negotiate upgrades associated with a particular property rental. In some embodiments, the intelligent property rental system may determine information that may be used to support such negotiations, such as the large number of available rental properties, and other information. In some embodiments, the intelligent property rental system can negotiate automatically based on ongoing authorization or blanket authorization from the user (or even without the user's input or authorization on an anonymous basis as an experiment to see the best deals it can achieve). In an example, the home owner may want $400 per night. Based on market analysis, the intelligent property rental system may automatically determine that the price is “too high” and may attempt to negotiate with the home owner to achieve a lower price, at which point the intelligent property rental system may present the negotiated price to the user as an “incredible deal” it negotiated on the user's behalf.

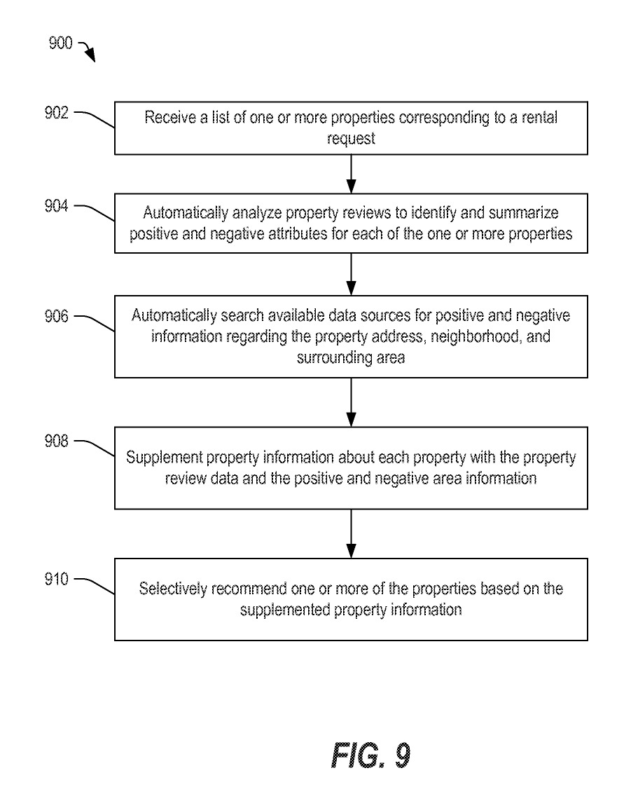

FIG. 9 is a flow diagram of a method 900 of providing a recommendation to a potential renter based on review data and area information as assessed and valued, in accordance with certain embodiments of the present disclosure. At 902, the intelligent property rental system may receive a list of one or more properties corresponding to a rental request. In some embodiments, the list may be received in response to one or more queries. Advancing to 904, the intelligent property rental system may automatically analyze property reviews from multiple places to identify and summarize positive and negative attributes for each of the one or more properties. In some embodiments, the intelligent property rental system may evaluate each review to identify the value of the reviewer and review itself (e.g., anonymous reviews may be planted or fake, a serial reviewer with good reviews by others should be given more credence particularly where the reviewer resembles the user, etc.).

Continuing to 906, the intelligent property rental system may automatically search available data sources for positive and negative information regarding the property address, neighborhood, and surrounding area. In some embodiments, the intelligent property rental system may evaluate such information to identify the value of the source and information itself (e.g., some sources will be more reliable or up-to-date than others). The information may include crime statistics, neighborhood amenities, schools information, and other information.

Moving to 908, the intelligent property rental system may supplement the property information about each property with the property review data and the positive and negative area information. Proceeding to 910, the intelligent property rental system may selectively recommend one or more of the properties based on the supplemented property information as assessed and valued. In some embodiments, the intelligent property rental system may provide advice with respect to decision-making surrounding certain rental options and may provide justifications for selecting one rental option over another. In some embodiments, the recommendation may also be based on one or more personas associated with a potential renter.

In some embodiments, the recommendations may be provided by adjusting a sort order of the one or more rental properties based on the information. In some embodiments, the recommendations may be provided by adding an indicator, a comment, a justification or other information indicating the recommendation.

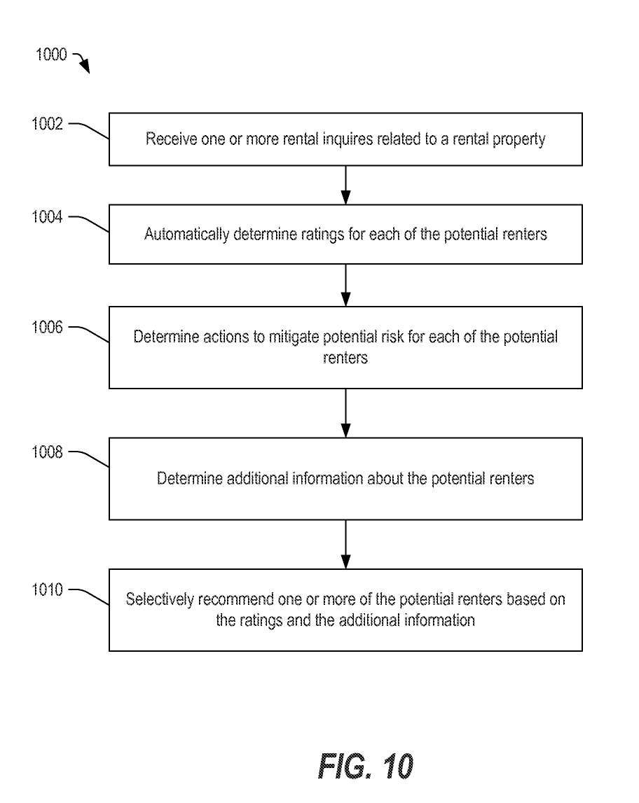

FIG. 10 is a flow diagram of a method 1000 of providing a recommendation to a property owner or manager, in accordance with certain embodiments of the present disclosure. At 1002, the intelligent property rental system may receive one or more rental inquiries that are related to a rental property. The rental inquiries may include requests for information, rental requests, offers, or other information.

Advancing to 1004, the intelligent property rental system may automatically determine ratings for each of the potential renters. The ratings may be based on information determined for each of the potential renters, including the intended use for a particular property (i.e., spring break, family vacation, bachelor party, etc.), information gleaned about the potential renters from reviews, third party sites (including employment information, bankruptcies etc). In some embodiments, the ratings may reflect a potential risk associated with each of the potential renters.

Continuing to 1006, the intelligent property rental system may determine actions to mitigate potential risk for each of the potential renters. Such risk mitigation may include increasing the rental price, increasing an associated deposit, providing other risk mitigation options, or any combination thereof.

Moving to 1008, the intelligent property rental system may determine additional information about the potential renters. Such additional information may include reviews from property owners/managers, information from social media websites, information from other sources, or any combination thereof. It should be appreciated that the determination of additional information about potential renters may occur at 1004 and may be included in the determination of actions to mitigate potential risk (1006).

Proceeding to 1010, the intelligent property rental system may selectively recommend one or more of the potential renters based on the ratings and the additional information as assessed and valued. In some embodiments, the intelligent property rental system may recommend one or more of the potential renters by adjusting a sort order of potential rental offers, by placing an indicator next to one or more of the renters/rental options, by providing another type of indicator (such as color coding), or any combination thereof. The comments and justifications may be included for both good and bad renters. The recommendation may be provided in a graphical user interface, which may be provided to a device associated with a property manager or owner.

The processes, machines, and manufactures (and improvements thereof) described herein are particularly useful improvements for computers using artificial intelligence based decision systems. Further, the embodiments and examples herein provide improvements in the technology of artificial intelligence based decision systems. In addition, embodiments and examples herein provide improvements to the functioning of a computer by providing enhanced results and dynamic intelligent decisions, thereby creating a specific purpose computer by adding such technology. Thus, the improvements herein provide for technical advantages, such as providing a system in which a user's interaction with a computer system and complex results or decisions are made easier. For example, the systems and processes described herein can be particularly useful to any systems in which a user may want to buy, lease, rent, search, exchange, bid, or barter for goods or services. Further, the improvements herein provide additional technical advantages, such as providing a system in which the personas can operate continuously, apply experiential learning to perform tasks, solve problems, make recommendations, and assist the user by helping manage the user's life experiences to make the user's life easier in terms of dealing with problems, anticipating and solving problems (sometimes before the user is even aware that a problem may exist), managing tasks, and ensuring that all aspects of the user's life receive due attention. While technical fields, descriptions, improvements, and advantages are discussed herein, these are not exhaustive and the embodiments and examples provided herein can apply to other technical fields, can provide further technical advantages, can provide for improvements to other technologies, and can provide other benefits to technology. Further, each of the embodiments and examples may include any one or more improvements, benefits and advantages presented herein.

It should be appreciated that the intelligent property rental system, instead of focusing on short or very short time windows (e.g., search results), may operate twenty four hours per day and seven days a week. The system may continuously search, learning from the results and interacting with suppliers, in order to be ready to respond with “better” and “best” options whenever a user interacts with the system. Further, the system may proactively search, find “best” options, and initiate user interactions to exceed a user's expectations. The system may be always on, always working, and always managing both the supplier's and the user's needs on an on-going basis.

The illustrations, examples, and embodiments described herein are intended to provide a general understanding of the structure of various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. For example, in the flow diagrams presented herein, in certain embodiments, blocks may be removed or combined without departing from the scope of the disclosure. Further, structural and functional elements within the diagram may be combined, in certain embodiments, without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the examples, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

Although the present invention has been described with reference to preferred embodiments, workers skilled in the art will recognize that changes may be made in form and detail without departing from the scope of the invention.

What is claimed is:

1. A system comprising:
an interface configured to communicate with a device through a network;
an artificial intelligence engine configured to:
identify information corresponding to at least one of a potential renter and a first rental property;
assess and value the information based on a context from which the information is identified;
determine a recommendation corresponding to the at least one; and
provide an interface to the device including the recommendation and a justification for the recommendation.

2. The system of claim 1, wherein the artificial intelligence engine is further configured to:
identify a plurality of rental properties including the first rental property; and
identify rental property information corresponding to at least one rental property of the plurality of rental properties, the rental property information including at least one of:
neighborhood information corresponding to a neighborhood that includes the at least one rental property, the neighborhood information including nearby amenities; and
reviews about the at least one rental property.

3. The system of claim 2, wherein the neighborhood information includes crime information.

4. The system of claim 2, wherein the artificial intelligence engine identifies the plurality of rental properties automatically based on prior rentals corresponding to a user.

5. The system of claim 2, wherein the artificial intelligence engine identifies the rental property information by searching reviews and social media comments.

6. The system of claim 1, wherein the artificial intelligence engine identifies information corresponding to a first rental property in response to receiving a rental request from the device, the rental request specifying one or more rental property parameters.

7. The system of claim 6, wherein the artificial intelligence engine is configured to:
determine a rental property that matches some but not all of the one or more rental property parameters; and
automatically send a message including data related to the one or more rental property parameters to a property manager to initiate a rental negotiation process.

8. The system of claim 7, wherein the artificial intelligence engine is configured to:
receive an offer from the owner;
automatically review the offer; and
selectively provide the offer to the device through at least one of the interface and a popup window associated with the interface.

9. The system of claim 1, wherein the artificial intelligence engine is configured to:
determine a digital persona from a plurality of digital personas based on information determined from data received from the device, each of the plurality of digital personas comprises a digital representation of one of a potential renter and a property owner, the digital persona including data representing preferences, rules, and priorities of one of the potential renter and the property owner; and
automatically determine the recommendation in response to determining the digital persona.

10. The system of claim 1, wherein the artificial intelligence engine is configured to:
identify one or more rental properties including the first rental property automatically or in response to a query; and
automatically communicate with one or more property managers to verify availability of at least one of the one or more rental properties.

11. The system of claim 10, wherein the artificial intelligence engine is configured to:
determine rental parameters associated with a selected one of the one or more rental properties; and
automatically communicate with a property owner of the selected one to negotiate at least one of the one or more rental parameters.

12. A method comprising:
automatically identifying information corresponding to at least one of a potential renter and a first rental property via an artificial intelligence engine;
automatically assessing and valuing, via the artificial intelligence engine, the information based on a context from which the information is identified;
determining, via the artificial intelligence engine, a recommendation corresponding to the at least one; and
providing an interface to a device via a network, the interface including the recommendation and a justification for the recommendation.

13. The method of claim 12, further comprising:
normalizing search results corresponding to a rental request at a normalizer of an intelligent property rental system to produce a list of rental properties, the rental request including one or more rental property parameters; and
providing the normalized search results to the artificial intelligence engine.

14. The method of claim 12, wherein automatically identifying, via the artificial intelligence engine, information comprises searching at least one of a web site and a database to determine at least one review associated with the potential renter.

15. The method of claim 14, further comprising automatically initiating, via the artificial intelligence engine, a negotiation with at least one of the property owner and the potential renter.

16. The method of claim 12, wherein before automatically identifying the information, the method further comprises:
automatically searching one or more data sources to identify a plurality of rental properties based on a digital persona associated with the device; and
automatically searching one or more data sources to identify information associated with the plurality of rental properties.

17. A system comprising:
an intelligent property rental system including:
a renter artificial intelligence (AI) engine adapted to provide a list of rental properties to a potential renter in response to a rental search, the list of rental properties customized to the potential renter based on one or more personas associated with the potential renter; and
a property owner/manager AI engine adapted to selectively interact with a property administrator to identify and mitigate risks associated with the potential renter.

18. The system of claim 17, wherein the renter AI engine is configured to:
determine past rental activity by proactively identify the list of rental properties based on past rental history associated with the potential renter; and
initiate contact with the potential renter to provide the list of rental properties proactively and without receiving a query from the potential renter.

19. The system of claim 17, wherein:
the renter AI engine is configured with one or more personas associated with the potential renter; and
the property owner/manager AI engine is configured with at least one persona associated with the property administrator.

20. The system of claim 17, wherein the property owner/manager AI engine provides, in response to one or more requests to rent a selected rental property, a recommended one of a plurality of potential renters and provides advice and at least one justification for renting to the recommended one or for not renting to another potential renter.

21. The system of claim 17, wherein the renter AI engine is configured to communicate automatically with the property owner/manager AI engine to verify availability of at least one of the rental properties.
